(19) United States
(12) Patent Application Publication
(10) Pub. No.: US 2015/0061401 A1
(43) Pub. Date: Mar. 5, 2015

(54) WIRELESS POWER TRANSFER SYSTEM, WIRELESS POWER TRANSFER APPARATUS, WIRELESS POWER TRANSFER METHOD, CONTROL METHOD FOR THE WIRELESS POWER TRANSFER APPARATUS, AND STORAGE MEDIUM STORING PROGRAM

(71) Applicant: CANON KABUSHIKI KAISHA, Tokyo (JP)

(72) Inventor: Hidetada Nago, Kawasaki-shi (JP)

(21) Appl. No.: 14/394,008

(22) PCT Filed: Mar. 29, 2013
(86) PCT No.: PCT/JP2013/002164

§ 371 Date: Oct. 10, 2014

(30) Foreign Application Priority Data
Apr. 13, 2012 (JP) 2012-092216

(51) Int. Cl. H04B 5/00; H01F 38/14

(52) U.S. Cl. CPC H04B 5/0037; H01F 38/14
USPC 307/104

(57) ABSTRACT

The disclosure relates to a wireless power transfer system composed of a power transmission apparatus including power transmission elements configured to transmit power and a power reception apparatus including power reception elements configured to receive the power. The wireless power transfer system communicates information related to the power transmission elements or the power reception elements between the power transmission apparatus and the power reception apparatus and selects a combination of the power transmission element and the power reception element used for wireless power transfer among plural combinations of the power transmission elements and the power reception elements by using the communicated information.

### TECHNICAL FIELD

The present invention relates to wireless power transfer.

### BACKGROUND ART

In recent years, a wireless power transfer system including a power transmission apparatus that transmits power in a wireless (non-contact) manner without a connection by a connector and a power reception apparatus that charges a mounted battery by using the power supplied from the power transmission apparatus is proposed. In the thus structured wireless power transfer system, for example, a technology of changing load resistances of a power transmission element and a power reception element, a power transmission voltage, a coil structure, or a coupling degree between coils and determining whether the efficiency before the change is improved after the change is proposed as a technology of increasing a power transfer efficiency (PTL 1). A technology is also proposed in which plural matching circuit units forming a wanted resonance frequency on a power transmission side are provided, and plural resonance points are realized without provision of plural power transmission coils so that power transmission and reception efficiencies are increased in accordance with resonance points on a power reception side (PTL 2).

A difference in the power transfer efficiency is generated because of each of combinations of plural power transmission coils having different sizes and shapes and having different sizes and shapes of power reception coils. In a power reception apparatus such as, for example, a digital camera or a laptop computer, a size of the power reception coil installed inside the apparatus is also restricted depending on the size of the apparatus and the product itself, and sizes of the respective power reception coils may be different from each other. In a case where the plural power reception apparatuses including the above-described power reception coils having the different sizes and shapes are charged by using a single power transmission apparatus, a problem occurs that the power transmission may efficiently be conducted for a certain apparatus, but the power transmission is not efficiently conducted for the other apparatus. Similarly, sizes of the power transmission apparatuses vary from one another. The sizes of the power transmission coils are different from each other in accordance with the power transmission apparatuses, and even in a case where a single power reception apparatus is charged, a difference in the power transfer efficiency may be generated depending on the sizes and shapes of the power transmission coils.

The technologies proposed in PTL 1 and PTL 2 are technologies of improving a decrease in the power transfer efficiency which is caused by a distance between the power transmission and reception coils, a location relationship, or a deviation of resonance points. The decrease in the power transfer efficiency caused by the combinations of the sizes and shapes of each of the power transmission and reception coils is however not taken into account in the proposed technologies.

### CITATION LIST

### Patent Literature

PTL 1: Japanese Patent Laid-Open No. 2010-252497

PTL 2: Japanese Patent Laid-Open No. 2012-34524

### SUMMARY OF INVENTION

The present invention relates to a wireless power transfer system composed of a power transmission apparatus including power transmission elements configured to transmit power and a power reception apparatus including power reception elements configured to receive the power. The wireless power transfer system communicates information related to the power transmission elements or the power reception elements between the power transmission apparatus and the power reception apparatus and selects a combination of the power transmission element and the power reception element used for wireless power transfer among plural combinations of the power transmission elements and the power reception elements by using the communicated information.

Further features of the present invention will become apparent from the following description of exemplary embodiments with reference to the attached drawings.

### BRIEF DESCRIPTION OF DRAWINGS

FIG. 1 illustrates a configuration of a wireless power transfer system according to an embodiment.

FIG. 2A illustrates a configuration of a power transmission apparatus.

FIG. 2B illustrates a configuration of the power transmission apparatus.

FIG. 3A illustrates a configuration of a power reception apparatus.

FIG. 3B illustrates a configuration of the power reception apparatus.

FIG. 4 is a flow chart illustrating an operation by the power transmission apparatus.

FIG. 5 is a flow chart illustrating an operation by the power reception apparatus.

FIG. 6 illustrates a transfer efficiency of each of plural combinations of power transmission elements and power reception elements.

FIG. 7 illustrates an example of the power transmission element.

FIG. 8 illustrates an example of the power transmission element.

FIG. 9 illustrates an example of the power reception element.

FIG. 10 illustrates an example of the power reception element.

FIG. 11 illustrates an example of the power transmission element.

FIG. 12 illustrates an example of the power transmission element.

FIG. 13 illustrates an example of the power reception element.

### DESCRIPTION OF EMBODIMENTS

A wireless power transfer system including a power transmission apparatus that transmits power and a power reception apparatus that receives the power according to the present embodiment will be described. Information related to the power transmission elements or the power reception elements is communicated between the power transmission apparatus and the power reception apparatus, and a combination of the power transmission element and the power reception element having satisfactory power transmission and reception efficiencies is selected according to the present embodiment. A configuration of the wireless power transfer system according to the present embodiment will be described by using FIG. 1. In FIG. 1, a power transmission apparatus 101 is composed of a wireless power transfer apparatus, and a power reception apparatus 102 is composed of a wireless power transfer apparatus. A wireless power system according to the present embodiment supplies power from the power transmission apparatus 101 to the power reception apparatus 102 on the basis of a magnetic field resonance system. The magnetic field resonance system is a system in which the power is transferred through coupling based on resonance (electric resonance) between a resonator (resonance element) provided in the power transmission apparatus 101 and a resonator (resonance element) provided in the power reception apparatus 102. The description will be made by using the wireless power transfer system using the magnetic field resonance system as an example according to the present embodiment, but the wireless power transfer system (non-contact power transfer system) is not limited to the above. A power transfer system utilizing electro-magnetic induction, electric field resonance, microwaves, laser (light), or the like may also be used.

The power transmission apparatus 101 includes plural power transmission elements (power transmission coils) having mutually different sizes and shapes. Examples of the power transmission elements will be illustrated in FIGS. 7, 8, 11, and 12. The power reception apparatus 102 is installed at a location on the power transmission apparatus 101 where power transmission can be conducted to charge a power supply unit of the power reception apparatus 102 by using the power wirelessly transferred from the power transmission apparatus 101.

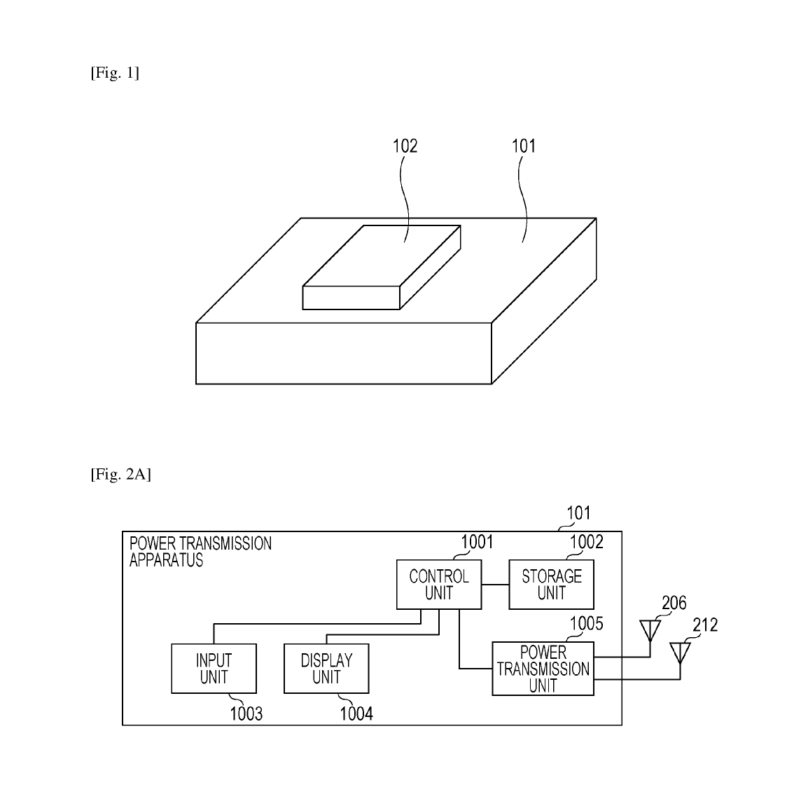

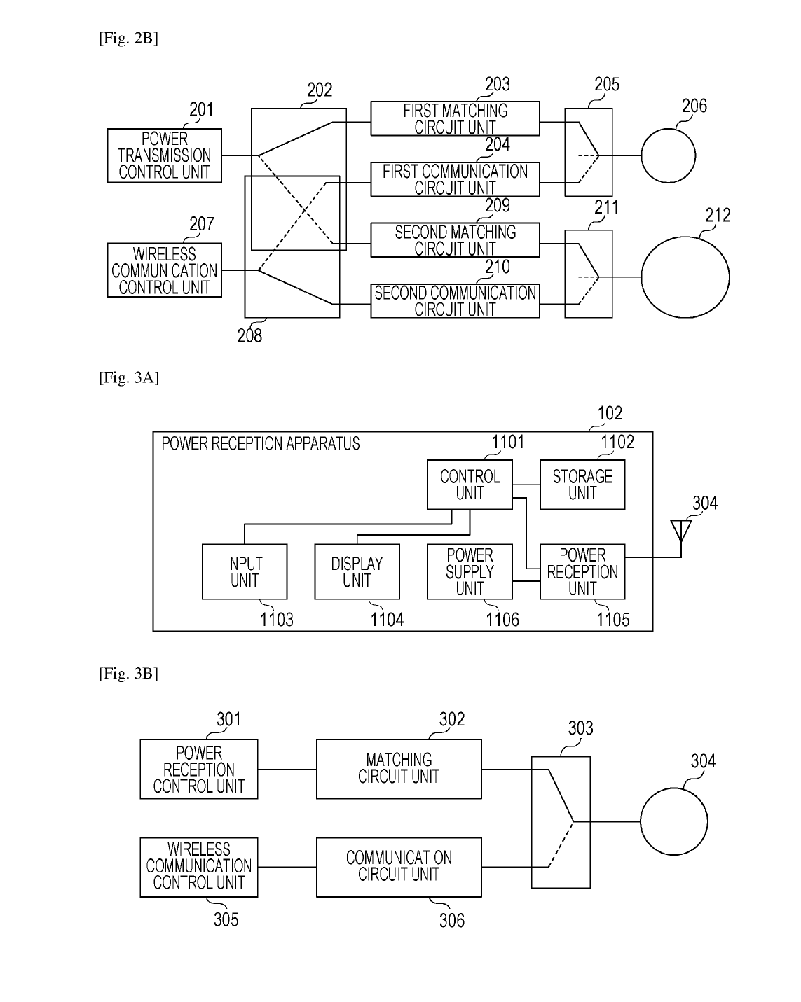

A hardware configuration of the power transmission apparatus 101 will be described by using FIG. 2A and FIG. 2B. FIG. 2A illustrates a configuration of an entirety of the power transmission apparatus 101. A control unit 1001 is configured to control the entire apparatus by executing a control program stored in a storage unit 1002. The storage unit 1002 stores the control program executed by the control unit 1001 and various pieces of information. Various operations which will be described below are carried out while the control program stored in the storage unit 1002 is executed by the control unit 1001. An input unit 1003 is used for a user to perform various inputs. A display unit 1004 performs various displays and has a function of outputting information that can visually be recognized like an LCD or an LED or a function of outputting sound like a speaker. A power transmission unit 1005 transmits power to the power reception apparatus 102. The power transmission unit 1005 communicates with the power reception apparatus 102.

FIG. 2B is an explanatory diagram for describing the power transmission unit 1005 in detail. In FIG. 2B, a power transmission control unit 201 controls power transmission. A first switching unit 202 switches a connection of the power transmission control unit 201 to a first matching circuit unit 203 or a second matching circuit unit 209. The first matching circuit unit 203 is composed of an inductor, a capacitor, or the like. The first matching circuit unit 203 is a circuit constituting a resonance circuit having a predetermined resonance frequency by being connected to a first power transmission element 206. The predetermined resonance frequency according to the present embodiment is set as 13.56 MHz.

A first communication circuit unit 204 is configured to perform a wireless communication by using radio waves transmitted and received by the first power transmission element 206. A second switching unit 205 switches a connection of the first power transmission element 206 to the first matching circuit unit 203 or the first communication circuit unit 204. The second switching unit 205 may set the first power transmission element 206 in an electrically open or short-circuited state. The first power transmission element 206 is a power transfer element for transferring the power. The first power transmission element 206 is composed of a coil. A wireless communication control unit 207 is a chip designed to wirelessly communication with another apparatus. A third switching unit 208 switches a connection of the wireless communication control unit 207 to the second matching circuit unit 209 or a second communication circuit unit 210. The second matching circuit unit 209 is composed of an inductor, a capacitor, or the like. The second matching circuit unit 209 is a circuit constituting a resonance circuit having a predetermined resonance frequency by being connected to a second power transmission element 212. The predetermined resonance frequency according to the present embodiment is set as 13.56 MHz.

The second communication circuit unit 210 is configured to perform a wireless communication by using radio waves transmitted and received by the second power transmission element 212. A fourth switching unit 211 switches a connection of the second power transmission element 212 to the second matching circuit unit 209 or the second communication circuit unit 210. The fourth switching unit 211 may set the second power transmission element 212 in an open or short-circuited state. The second power transmission element 212 is a power transfer element for transferring the power. The second power transmission element 212 is composed of a coil.

According to the present embodiment, the first switching unit 202, the second switching unit 205, the third switching unit 208, and the fourth switching unit 211 switch the presence or absence of the physical connections of the respective elements but may be composed of units configured to avoid electric connections of the respective elements by using a rectifier such as, for example, a diode.

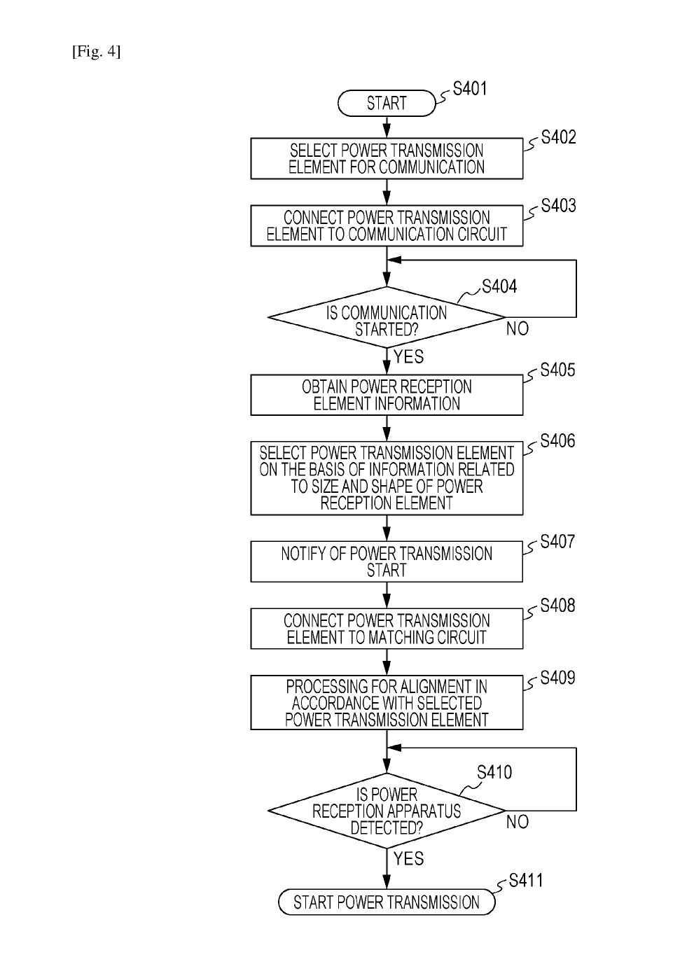

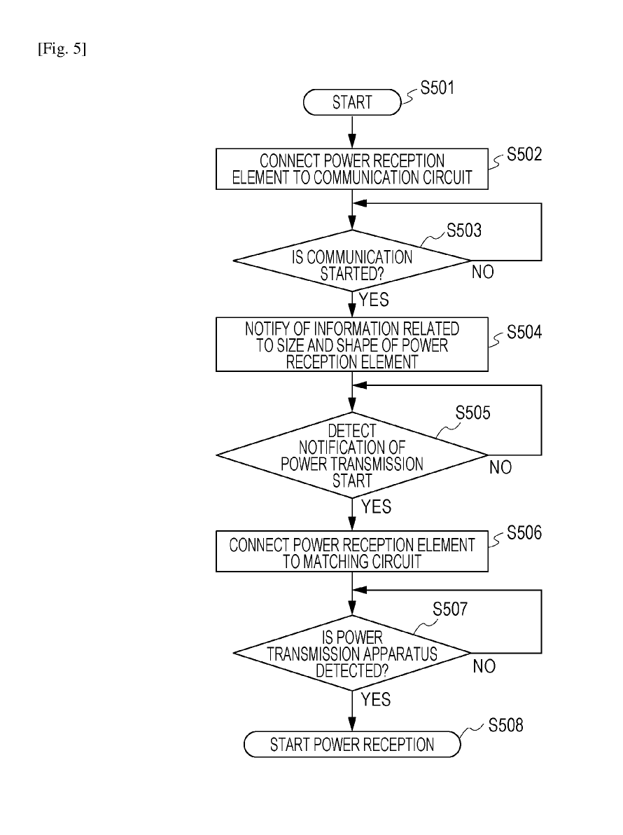

FIG. 3A and FIG. 3B illustrate a hardware configuration of the power reception apparatus 102. FIG. 3A illustrates a configuration of the entire apparatus. The power reception apparatus 102 corresponds to the entire apparatus. A control unit 1101 controls the entire apparatus by executing a control program stored in a storage unit 1102. The storage unit 1102 stores the control program executed by the control unit 1101 and various pieces of information. The various operations are carried out while the control program stored in the storage unit 1102 is executed by the control unit 1101. An input unit 1103 is used for the user to perform various inputs. A display unit 1104 performs various displays and has a function of outputting information that can visually be recognized like an LCD or an LED or a function of outputting sound like a speaker. A power reception unit 1105 charges a power supply unit 1106 by using the power wirelessly transmitted from the power transmission apparatus 101. The power reception unit 1105 performs a communication with the power transmission apparatus 101.

FIG. 3B is an explanatory diagram for describing the power reception unit 1105 in detail. FIG. 3B illustrates a block configuration of the power reception unit 1105. In FIG. 3B, a power reception control unit 301 controls power reception. A matching circuit unit 302 is composed of an inductor, a capacitor, or the like. The matching circuit unit 302 is a circuit constituting a resonance circuit having a predetermined resonance frequency by being connected to a power reception element 304. The predetermined resonance frequency according to the present embodiment is set as 13.56 MHz. A switching unit 303 is designed to switch a connection of the power reception element 304 to the matching circuit unit 302 or a communication circuit unit 306. The power reception element is a power transfer element for transferring the power. The power reception element 304 is composed of a coil. A wireless communication control unit 305 is a chip designed to wirelessly communication with another apparatus. The communication circuit unit 306 is configured to conduct a wireless communication by using radio waves transmitted and received by the power reception unit 1105. According to the present embodiment, the switching unit 303 switches the presence or absence of the physical connections of the respective elements but may be composed of a unit configured to avoid electric connections of the respective elements by using a rectifier such as, for example, a diode.

A case in which a Near field communication (NFC) is used as a communication system for a communication between the power transmission apparatus 101 and the power reception apparatus 102 will be described according to the present embodiment. The wireless power transfer is conducted in a same frequency band as a frequency band used for the NFC communication. Therefore, a power transmission element used for the wireless power transfer may be used as an antenna used for the NFC communication. In a communication based on the NFC communication, a difference in the transfer efficiency depending on combinations of the sizes and shapes of the antennas on the transmission side and the reception side is relatively small. However, a difference in the transfer efficiency depending on combinations of the sizes and shapes of the power transmission elements and power reception elements in the wireless power transfer is relatively large. The communication may satisfactorily be conducted even in a case where the same element is used, but a problem may occur that the transfer efficiency is degraded in the wireless power transfer.

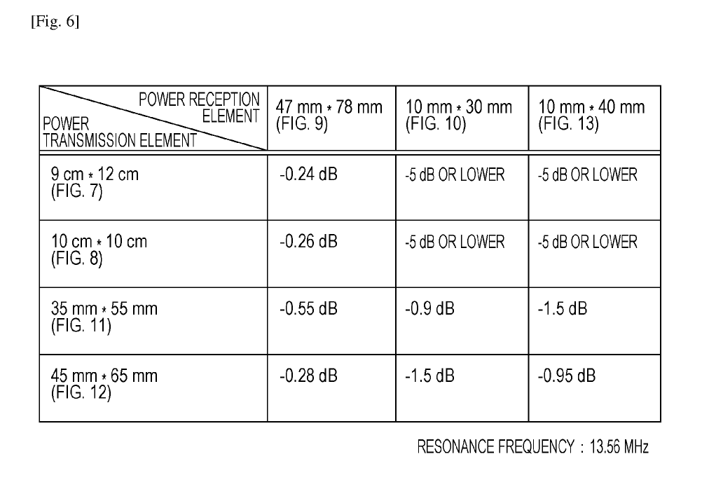

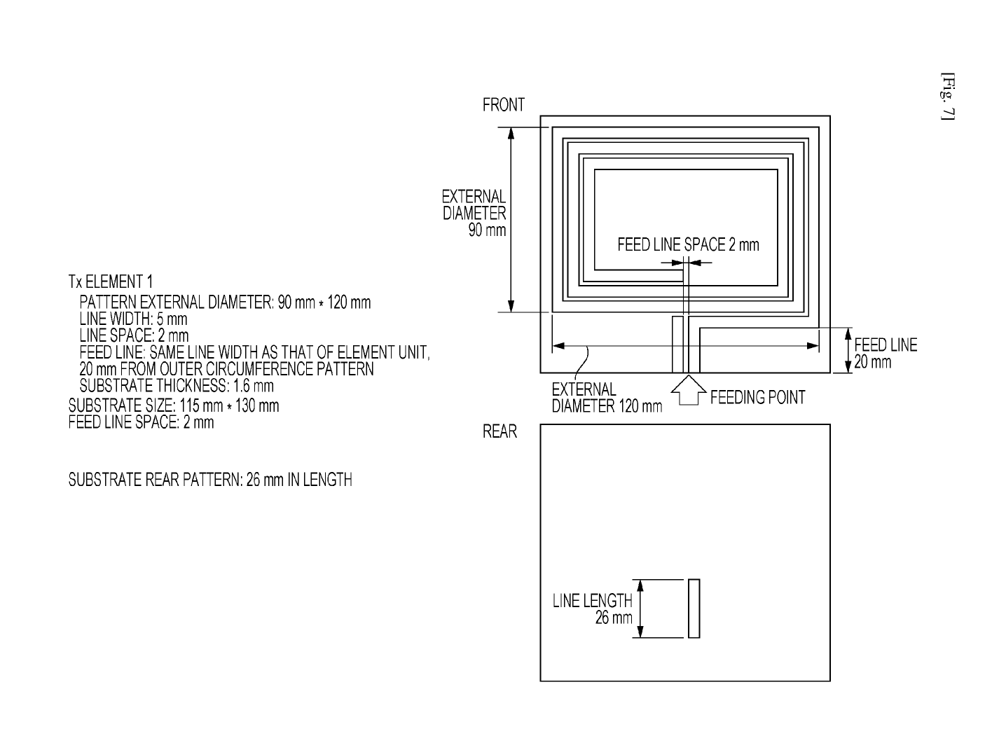

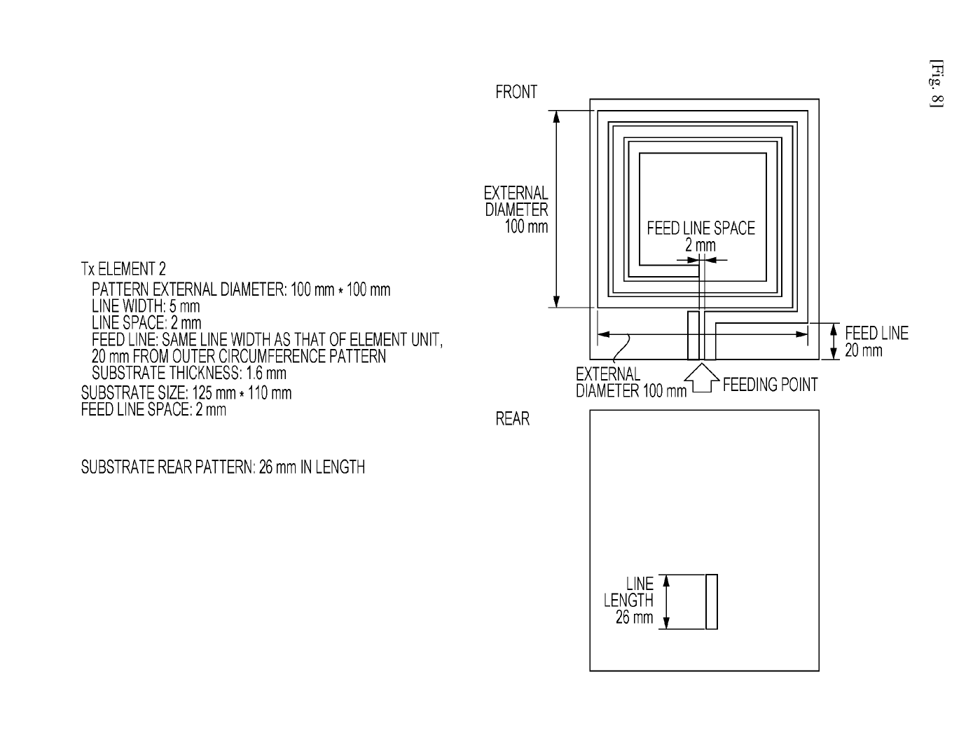

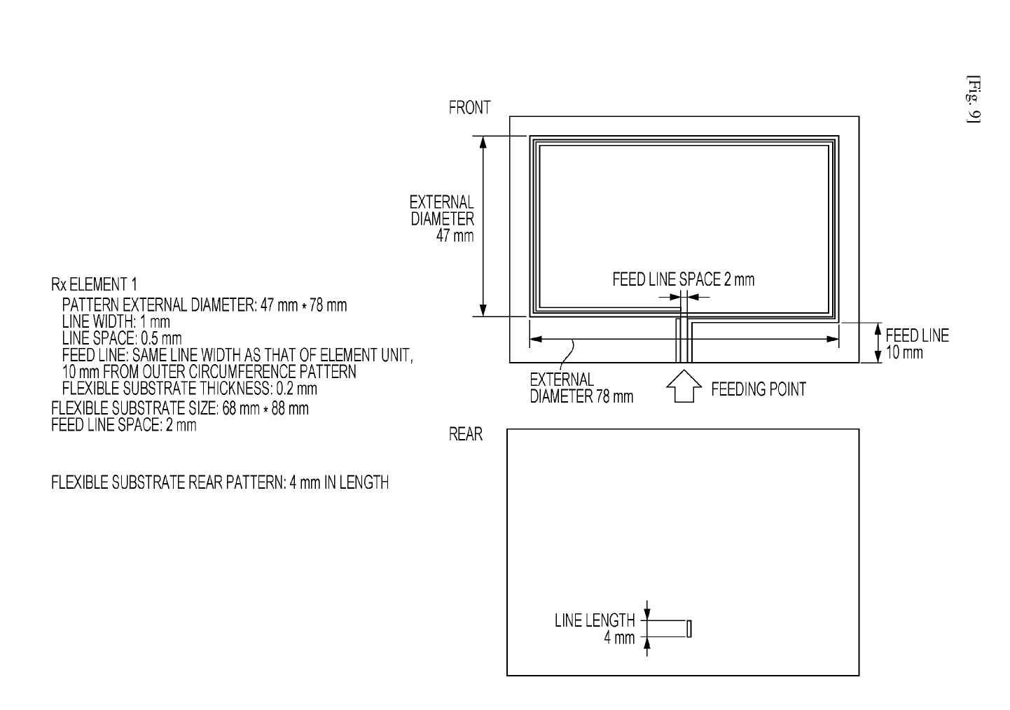

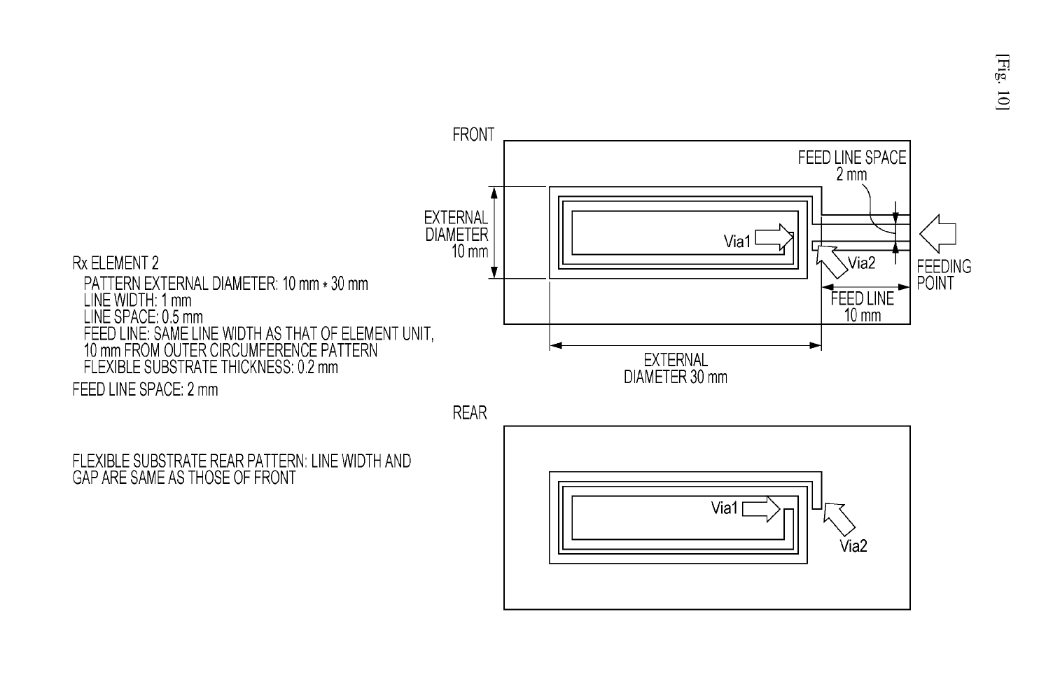

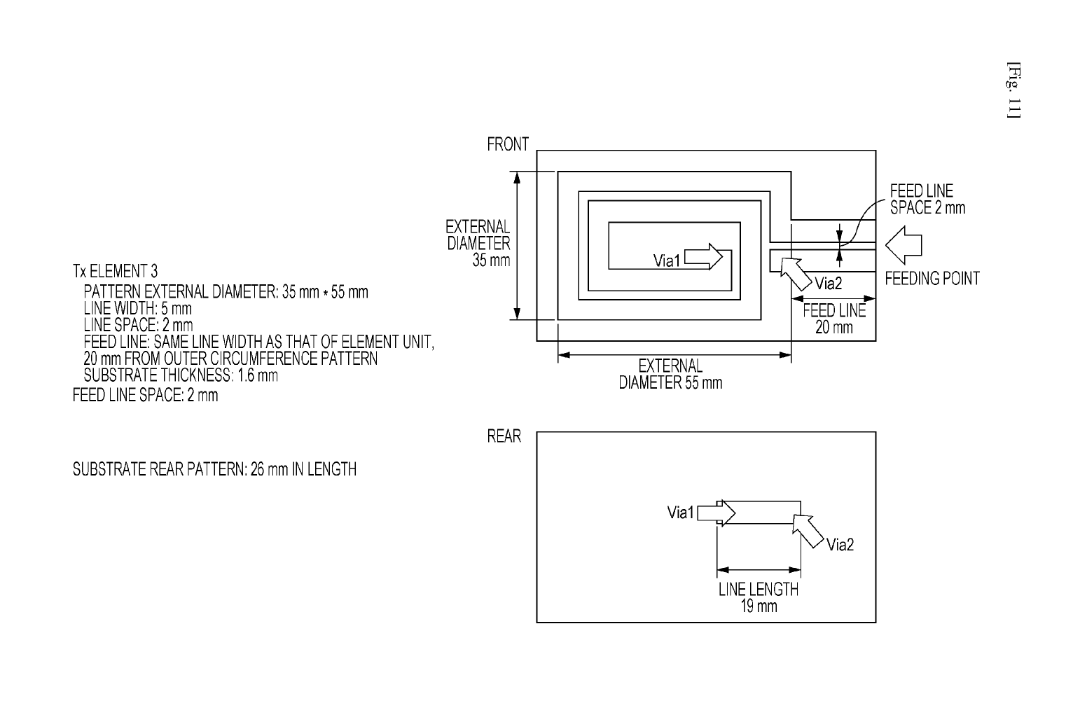

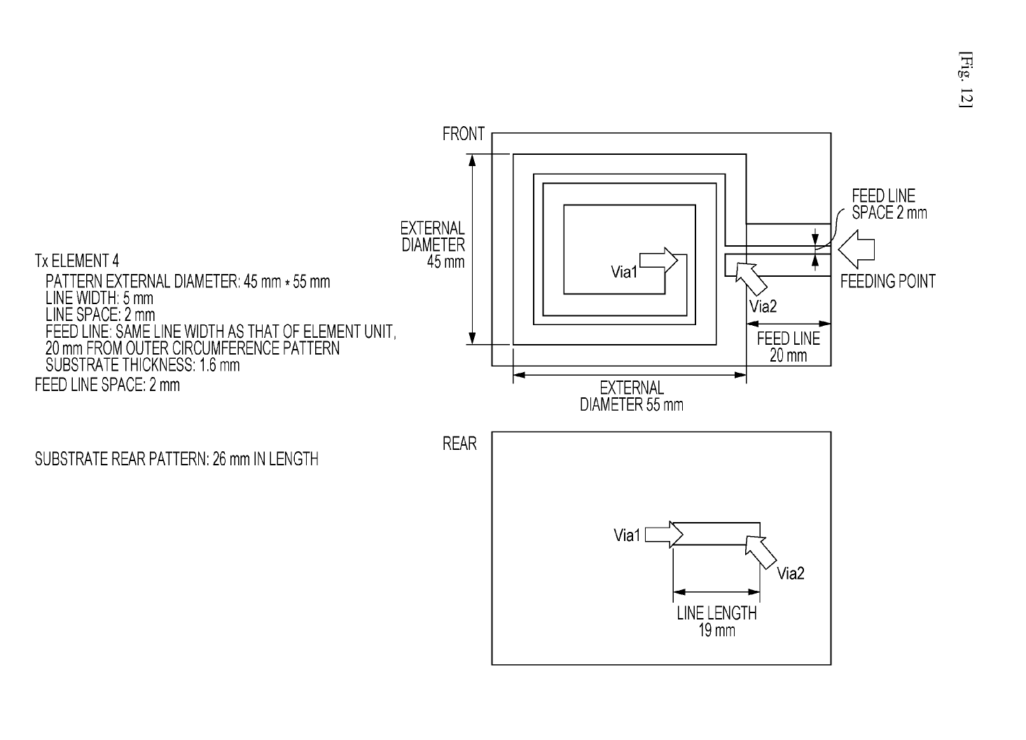

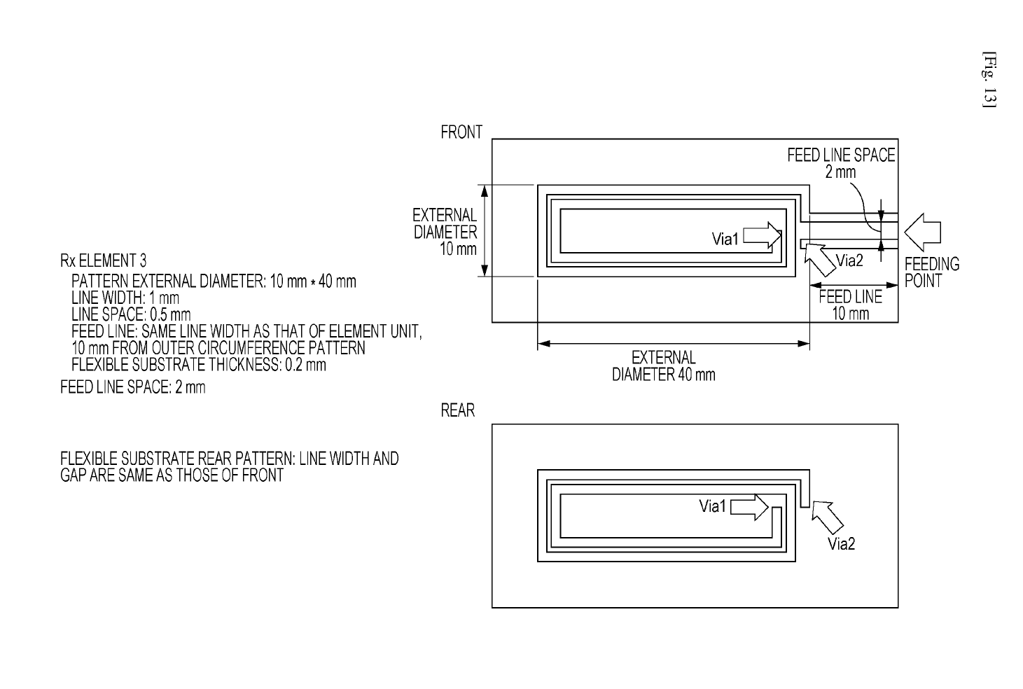

Combinations of plural power transmission elements having different sizes and plural power reception elements having different sizes will be described by using FIG. 6. FIG. 6 also illustrates a transfer efficiency at the time of conducting the wireless power transfer in each of the combinations. In FIG. 6, the respective elements are represented by a vertical and horizontal size, and a transfer efficiency at a time when the power transmission element and the power reception element are combined with each other is indicated by dB. The transfer efficiency takes a minus value while the transfer efficiency is higher as the value is closer to 0 dB. FIG. 7, FIG. 8, FIG. 11, and FIG. 12 illustrate examples of the power transmission element. FIG. 9, FIG. 10, and FIG. 13 illustrate examples of the power reception element. The measurement on the transfer efficiency in FIG. 6 is conducted while a center point of the power transmission element and a center point of the power reception element are overlapped with each other. The measurement on the transfer efficiency is conducted while each of the power transmission elements and the power reception elements is connected to a matching circuit to resonate at a resonance frequency of 13.56 MHz.

In FIG. 6, for example, the wireless power transfer is conducted by using the power transmission element at 10 cm*10 cm illustrated in FIG. 8 with respect to each of the power reception elements illustrated in FIG. 9, FIG. 10, and FIG. 13. The power transmission is conducted at a relatively satisfactory transfer efficiency of −0.26 dB with respect to the power reception element illustrated in FIG. 9. On the other hand, the power transmission is conducted at a dissatisfactory transfer efficiency of −5 dB or lower with respect to the power reception elements illustrated in FIG. 10 and FIG. 13. However, when the wireless power transfer is conducted by using the power transmission element at 35 mm*55 mm illustrated in FIG. 11 with respect to the power reception element illustrated in FIG. 10, the transfer efficiency is improved to −0.9 dB as compared with the case of using the power transmission element illustrated in FIG. 8. The difference in the transfer efficiency is generated in this manner depending on the combinations of the sizes and shapes of the respective power transmission and reception elements. According to the present embodiment, the wireless power transfer is conducted by using a combination of power transmission and reception elements having a satisfactory transfer efficiency on the basis of the sizes and shapes of the respective power transmission and reception elements.

A specific operation by the wireless power system according to the present embodiment will be described by using flow charts illustrated in FIG. 4 and FIG. 5. The following processing is realized while control programs stored in respective apparatuses are executed by a control unit to control computation and process on information and respective pieces of hardware. The control unit executes the programs, and a part or all of function configurations realized through the computation and process on the information or the like may be realized by the hardware in the following flow chart.

An operation by the power transmission apparatus 101 will be described by using a flow chart illustrated in FIG. 4. An operation by the power reception apparatus 102 will be described by using a flow chart illustrated in FIG. 5. When the power transmission apparatus 101 starts the operation (S401), one of the plural power transmission elements for establishing a communication with another apparatus is selected. In a case where the NFC communication is conducted, for example, by the first power transmission element 206 (S402), the second switching unit 205 connects the first power transmission element 206 to the first communication circuit unit 204. The third switching unit 208 establishes a connection between the first communication circuit unit 204 and the wireless communication control unit 207 (S403). On the other hand, when the power reception apparatus 102 starts the operation (S501), the switching unit 303 connects the power reception element 304 to the communication circuit unit 306 to perform a communication (S502).

The power transmission apparatus 101 and the power reception apparatus 102 are approximated to each other by a user. It is subsequently determined whether or not the communication is started in accordance with the mutual detection of the presence of the other apparatus within a communicable range by the power transmission apparatus 101 and the power reception apparatus 102 (S404), (S503). When the NFC communication is conducted between the power transmission apparatus 101 and the power reception apparatus 102, the power reception apparatus 102 notifies the power transmission apparatus 101 of information on the size or the shape of at least the power reception element 304 (S504). The information related to the element size herein may include an area, a structure, an external diameter, an outer circumference, and a winding number of the coil of the element, and the like. The elements illustrated in FIGS. 7 to 13 have a rectangular shape but may have other shapes. Information related to these shapes and information related to the size in accordance with the shape may be communication between the power transmission apparatus 101 and the power reception apparatus 102. The information related to the size in accordance with the shape may be, for example, information on a radius, a diameter, a circumference, and the like when the power transfer element has a circular shape.

The power transmission apparatus 101 that obtains the information on the power reception element 304 (S405) selects the power transmission element corresponding to the size and the shape of the power reception element 304 (S406). A table indicating the transfer efficiencies between the power transmission elements illustrated in FIG. 6 may be held at this time and used when the selection is made. A consideration will be given of a case, for example, in which the first power transmission element 206 has a size of 45 mm*65 mm illustrated in FIG. 12, the second power transmission element 212 has a size of 9 cm*12 cm illustrated in FIG. 7, and the power reception element 304 has a size of 47 mm*78 mm. In this case, the power transmission apparatus 101 selects the second power transmission element 212 at 12 cm*9 cm which has the better transfer efficiency than the other power transmission element for the power transmission element used for the power transmission on the basis of the table illustrated in FIG. 6. When the power reception element 304 has a size of 10 mm*40 mm, the power transmission apparatus 101 selects the first power transmission element 206 at 45 mm*65 mm from FIG. 6 for the power transmission element used for the power transmission. The power transmission apparatus 101 may calculate an area ratio of each of the plural power transmission elements to the power reception element on the basis of the information related to the area of the power reception element obtained from the power reception apparatus 102 through the communication and select the power transmission element on the basis of the area ratio for the power transmission element used for the power transmission.

When the selection of the power transmission element is ended, the power transmission apparatus 101 notifies the power reception apparatus 102 of a message indicating a start of the power transmission (S407). The power transmission apparatus 101 conducts matching circuit switching (S408). In the power transmission apparatus 101, in a case where the first power transmission element 206 is selected, the second switching unit 205 connects the first power transmission element 206 to the first matching circuit unit 203. This is because the communication circuit unit 306 or the wireless communication control unit 305 is protected since the power of the radio waves used for the power transfer is larger than the power of the radio waves used for the NFC communication so that the communication circuit unit 306 or the wireless communication control unit 305 may be damaged by the power of the radio waves used for the power transfer. Therefore, when the power transfer is conducted, the communication circuit unit 306 is not electrically connected to the wireless communication control unit 305.

The first switching unit 202 connects the first matching circuit unit 203 to a power transmission unit. The power transmission apparatus 101 sets the second power transmission element 212 that is not selected by the fourth switching unit 211 as an open or short-circuit state. This is because, if the power transmission element that is not selected remains being connected to one of the matching circuits, a circuit characteristic of the selected power transmission element is changed. This change may cause a decrease in the transfer efficiency. The state of the power transmission element that is not selected may be switched into the open or short-circuit state depending on whether the NFC communication is conducted or the wireless power transfer is conducted. In a case where the second power transmission element 212 is selected, the fourth switching unit 211 connects the second power transmission element 212 to the second matching circuit unit 209. The third switching unit 208 connects the second matching circuit unit 209 to the power transmission unit. The second switching unit 205 sets the first power transmission element 206 as an open or short-circuit state.

The power transmission apparatus 101 subsequently performs processing for alignment in accordance with the selected power transmission element (S409) to suppress the decrease in the transfer efficiency caused by a displacement between the power transmission element and the power reception element. The power transmission apparatus 101 presents an installation location of the power reception apparatus 102 to the user, for example, in accordance with the selected power transmission element via the display unit 1004. In a case where the power transmission element used in the NFC communication is different from the power transmission element used in the wireless power transfer, a display for urging the user to move the power reception apparatus 102 is also conducted. If the power transmission apparatus 101 may move the selected power transmission element by using a motor or the like, processing of moving the selected power transmission element to the power transmission location where the power reception apparatus 102 is installed is conducted. The power transmission control unit 201 subsequently detects the power reception apparatus 102 (S410). When the power reception apparatus 102 is detected, a power transmission sequence is started (S411).

After the notification to the power reception element, in response to the notification of the power transmission start (S505), the power reception apparatus 102 performs the matching circuit switching (S506). The switching unit 303 is controlled, and the power reception element 304 is connected to the matching circuit unit 302. This is because if the power transmission is started while the power reception element 304 remains to be connected to the communication circuit unit 306, the communication circuit unit 306 and the wireless communication control unit 305 may not normally operate because of the transmitted power. Therefore, when the power transfer is conducted, the power reception element 304 is not connected to the communication circuit unit 306.

When the power transmission apparatus 101 is detected on the basis of the power for the detection or the like from the power transmission apparatus 101 (S507), the power reception apparatus 102 starts to receive the power transmitted from the power transmission apparatus 101 (S508).

As described above, the power transmission apparatus 101 selects the power transmission element having the highest efficiency among the plural power transmission elements having the mutually different sizes or shapes on the basis of the information related to the size and the shape of the power reception element notified from the power reception apparatus 102, so that it is possible to conduct the power transmission to the power reception apparatus 102.

According to this configuration, the power transmission apparatus 101 selects the power transmission element used for the power transmission, but the power reception apparatus 102 may select the power transmission element of the power transmission apparatus 101 and instruct the power transmission apparatus 101 on the power transmission element used for the power transmission. In this case, instead of the obtainment of the information related to the size and the shape of the power reception element, the power transmission apparatus 101 notifies the power reception apparatus 102 of all pieces of information related to the sizes of the plural power transmission elements by using the wireless communication control unit 305. The power reception apparatus 102 selects the power transmission element preferably used with its own power reception element among power transmission elements on the basis of the obtained information related to the sizes and shapes of the power transmission elements. A method of selecting the power transmission element is similar to the case in which the power transmission element is selected on the side of the power transmission apparatus 101. The power reception apparatus 102 subsequently notifies the power transmission apparatus 101 of information related to the selected power transmission element by the wireless communication control unit 305. The power transmission apparatus 101 selects the power reception apparatus 102 and connects the instructed power transmission element to the power transmission unit to carry out the power transmission.

The power reception apparatus 102 may include plural power reception elements having different sizes and shapes and select the power reception used for the power reception on the basis of the information related to the sizes and shapes of the power transmission elements from the power transmission apparatus 101. The embodiment of the present invention may also be applied to a case in which the power transmission apparatus 101 includes plural power transmission elements having different sizes and shapes and the power reception apparatus 102 includes plural power reception elements having different sizes and shapes. In this case, at least one of the power transmission apparatus 101 and the power reception apparatus 102 communicates the information related to the sizes of the elements and selects a combination of the power transmission element and the power reception element used for the power transmission and reception as a system.

In a case where the frequency of radio waves used for the wireless power transfer is different from the frequency of radio waves used for the communication, a communication circuit may regularly be connected to an element for the communication. In a case where the power transmission apparatus 101 superimposes a control signal on the transmitted power, and a load modulation is conducted on the received power on the side of the power reception apparatus 102 to perform the communication with the power transmission apparatus 101 in the wireless power transfer, only the first switching unit 202 is used, and other switching units are not used.

As described above, according to the present embodiment, the information related to the sizes and shapes of the power transmission elements or the power reception elements is communicated, and the wireless power transfer may be conducted with the combination of the power transmission element or the power reception element having the satisfactory transfer efficiency on the basis of the information related to the size and the shape. Even in a case where the communication based on the NFC communication and the element used for the wireless power transfer are commonly be used, the communication may satisfactorily be conducted, and also the problem of the decrease in the transfer efficiency may be suppressed in the wireless power transfer.

According to the above-described embodiment, the configuration has been described in which the information related to the power transfer element is communicated, and the element used for the wireless power transfer is selected among the plural wireless power transfer elements on the basis of the communicated content. According to another embodiment, a communication on the information related to the power transfer system may be conducted with another apparatus, and the element used for the wireless power transfer may be selected among the plural wireless power transfer elements on the basis of the power transfer system dealt with by the other apparatus.

According to another embodiment, the wireless power transfer may be started by using the element selected in S406 or the like, and in a case where the efficiency of the wireless power transfer is below a predetermined value, the element may be selected again.

According to the above-described embodiment, the case has been described in which the wireless power transfer is conducted by using the single power transfer element, but the wireless power transfer may be conducted by using plural elements. For example, a wireless power transfer apparatus including at least three or more power transfer elements may select two or more elements among the three or more power transfer elements to perform the wireless power transfer by using information communicated with another wireless power transfer apparatus. The information communicated with the other wireless power transfer apparatus in this case may include information related to the power transfer element and information related to a location.

### Other Embodiments

Embodiments of the present invention can also be realized by executing the following processing. That is, the processing includes supplying software (program) that realizes the functions of the above-described embodiments to a system or an apparatus via a network or various storage media and causing a computer (or a CPU or an MPU) of the system or the apparatus to read out and execute the program.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-092216, filed Apr. 13, 2012, which is hereby incorporated by reference herein in its entirety.

1. A wireless power transfer system composed of a power transmission apparatus including power transmission elements configured to transmit power and a power reception apparatus including power reception elements configured to receive the power, the wireless power transfer system comprising:
a communication unit configured to communicate information related to a wireless power transfer system supported by the power transmission apparatus or the power reception elements between the power transmission apparatus and the power reception apparatus; and
a selection unit configured to select a combination of the power transmission element and the power reception element used for wireless power transfer among a plurality of combinations of the power transmission elements and the power reception elements by using the information communicated by the communication unit.

2. A wireless power transfer apparatus that performs wireless power transfer with another apparatus, the wireless power transfer apparatus comprising:
a plurality of power transfer elements configured to transfer power; an obtaining unit configured to obtain information related to a wireless power transfer system supported by the other apparatus; and
a selection unit configured to select the power transfer element used for the wireless power transfer among the plurality of power transfer elements by using the information obtained by the obtaining unit.

3. The wireless power transfer apparatus according to claim 2, wherein the obtaining unit obtains information related to power transfer elements of the other apparatus, and wherein the selection unit selects the power transfer element used for the wireless power transfer among the plurality of power transfer elements by using the information related to the power transfer elements of the other apparatus.

4. The wireless power transfer apparatus according to claim 2, wherein the obtaining unit obtains the information related in accordance with a situation in which the wireless power transfer apparatus and the other apparatus are approximated to each other within a communicable range.

5. The wireless power transfer apparatus according to claim 2, further comprising a movement unit configured to move the power transfer element selected by the selection unit while corresponding to a location of the other apparatus.

6. The wireless power transfer apparatus according to claim 2, further comprising a unit configured to set the power transfer elements that are not selected by the selection unit among the plurality of power transfer elements in an electrically open or short-circuited state.

7. The wireless power transfer apparatus according to claim 2, further comprising a notification unit configured to notify the other apparatus of start of power transfer.

8. The wireless power transfer apparatus according to claim 2, wherein the obtaining unit obtains the information through a communication with the other apparatus by using the power transfer element.

9. The wireless power transfer apparatus according to claim 7, further comprising a power transfer unit configured to perform power transfer with the other apparatus by using the power transfer element selected by the selection unit, wherein the power transfer element is not connected to a circuit configured to perform a communication when the power transfer is performed by the power transfer unit.

10. The wireless power transfer apparatus according to claim 2, wherein the plurality of power transfer elements have mutually different sizes or shapes.

11. The wireless power transfer apparatus according to claim 2, wherein the wireless power transfer apparatus is a power transmission apparatus that transmits power.

12. The wireless power transfer apparatus according to claim 2, wherein the wireless power transfer apparatus is a power reception apparatus that receives power.

13. The wireless power transfer apparatus according to claim 2, further comprising a display unit configured to perform a display for urging a user to move the other apparatus to a location corresponding to the power transfer element selected by the selection unit.

14. (canceled)

15. The wireless power transfer apparatus according to claim 2, wherein in a case where a power transfer efficiency at a time when the power transfer element selected by the selection unit is used is below a predetermined value, the selection unit selects a power transfer element again.

16. The wireless power transfer apparatus according to claim 2,
wherein the plurality of power transfer elements are three or more power transfer elements, wherein the selection unit selects two or more power transfer elements among the plurality of power transfer elements, and
wherein the wireless power transfer apparatus performs the power transfer with the other apparatus by using the selected two or more power transfer elements.

17. (canceled)

18. A wireless power transfer method for a wireless power transfer system composed of a power transmission apparatus including power transmission elements configured to transmit power and a power reception apparatus including power reception elements configured to receive the power, the wireless power transfer method comprising:
communicating information related to a wireless power transfer system supported by the power transmission apparatus or a wireless power transfer system supported by the power reception elements between the power transmission apparatus and the power reception apparatus; and
selecting a combination of the power transmission element and the power reception element used for wireless power transfer among a plurality of combinations of the power transmission elements and the power reception elements by using the information communicated the communication unit.

19. A control method for a wireless power transfer apparatus including a plurality of power transfer elements configured to perform power transfer with another apparatus, the control method comprising:
obtaining information related to power transfer elements of the other apparatus; and
selecting the power transfer element used for the power transfer among the plurality of power transfer elements by using the obtained information.

20. (canceled)

21. A storage medium storing a program for causing a computer to operate as the apparatus according to claim 19.

22. A storage medium storing a program for causing a computer to operate as the apparatus according to claim 20.
